(19) United States
(12) Patent Application Publication
(10) Pub. No.: US 2017/0276958 A1
(43) Pub. Date: Sep. 28, 2017

(54) EYEGLASS FRAME WITH REPLACEABLE TEMPLES

(71) Applicant: CLEARVISION OPTICAL CO., INC., Hauppauge, NY (US)

(72) Inventor: David Friedfeld, Dix Hills, NY (US)

(21) Appl. No.: 15/468,997

(22) Filed: Mar. 24, 2017

Related U.S. Application Data
(60) Provisional application No. 62/313,373, filed on Mar. 25, 2016.

(51) Int. Cl. G02C 5/14; G02C 5/00; G02C 5/22; G02C 5/16

(52) U.S. Cl. CPC G02C 5/146; G02C 5/16; G02C 5/008; G02C 5/2218; G02C 2200/08

(57) ABSTRACT

Eyeglasses with replaceable temples, and exemplary mechanisms to attach a frame-connected portion to a replaceable temple portion, are presented. An eyeglass frame can be attached to a hinged metal piece. The hinged metal piece can have a front solid portion and a rear bezel, including a spring and mesa portion. The spring and mesa portion can include a resilient spring material and an upwardly protruding mesa, and can be inserted into a cavity in a temple piece, and locked into place. By providing numerous temple pieces having essentially the same cavity dimensions, the eyeglasses can be used with an assortment of interchangeable temple pieces, which can be changed at will, effectively giving a wearer many looks and styles from the same basic frame, with the same lenses.

### CROSS-REFERENCE TO RELATED PROVISIONAL APPLICATION

This application claims the benefit of U.S. Provisional Patent Application No. 62/313,373, filed on Mar. 25, 2016, the disclosure of which is hereby incorporated herein by reference in its entirety.

### TECHNICAL FIELD

The present invention relates to eyeglass frames, and in particular to a novel eyeglass frame with replaceable temples.

### BACKGROUND OF THE INVENTION

Conventional eyeglasses require a user to choose a frame and then have an optician or optical company insert custom ground lenses into it. The user often spends significant time in choosing a frame. However, unless one re-orders new eyeglasses annually, or even semi-annually, as fashions and user mood change, the chosen frames often lose the luster they had at the time they were chosen.

Additionally, one style of frame may be more casual, and another more formal or business-like. Some frames are better suited to evening wear, and others to a summer outing. If an eyeglass wearer wants to coordinate eyeglasses to the rest of his or her outfits, this requires the purchase of multiple eyeglasses. Thus, one may purchase multiple sets of eyeglasses and then wear them at different times and contexts as one wears different suits or shoes. However, this is not only expensive, but one is still locked into the styles, patterns and colors available at the time the glasses were ordered. The glasses, once purchased, cannot be updated as styles, color palettes and other details change with time.

What is needed in the art is a solution to the above problems that allows users the freedom to customize their eyeglass frames as they see fit, and to be able to change the look, color, pattern and style of frames according to their moods or needs without purchasing new or multiple pairs of eyeglasses.

### SUMMARY OF THE INVENTION

Generally speaking, it is an object of the present invention to provide eyeglasses with replaceable temples, and exemplary mechanisms to attach a frame-connected portion to a replaceable temple portion. In exemplary embodiments of the present invention, an eyeglass frame can be permanently attached to a hinged metal piece. The eyeglass frame may have custom manufactured prescription lenses for a given user. The hinged metal piece can have, on the portion not attached to the frame, a front solid portion and a rear bezel that includes a spring and mesa portion. The spring and mesa portion can include a resilient spring material and an upwardly protruding mesa. The spring and mesa portion is arranged to be inserted into a cavity in a temple piece, and locked into place. It is the mesa portion that (i) a user can push down upon, against the force of the spring, to allow the bezel to be inserted into the cavity of the temple piece, and (ii) which locks the mesa of the bezel into the temple piece when the bezel is fully inserted. By manufacturing numerous temple pieces having essentially the same cavity dimensions, the eyeglasses can be used with an assortment of interchangeable temple pieces, which can be changed at will, and which can be purchased over the lifetime of the front frame portion, effectively giving a wearer many looks and styles from the same basic frame, with the same lenses.

Still other objects and advantages of the present invention will in part be obvious and will in part be apparent from the specification, and the scope of the invention will be indicated in the claims.

The present invention accordingly comprises the features of construction, combinations of elements, and arrangement of parts, all as exemplified in the constructions herein set forth.

### BRIEF DESCRIPTION OF THE DRAWINGS

The inventive embodiments are described in greater detail hereinafter with reference to the accompanying drawing figures, in which:

FIG. 1 is a plan view of an exemplary replaceable temple and a male bezel element inserted therein, according to an exemplary embodiment of the present invention;

FIG. 2 is a plan view of the male bezel element shown in FIG. 1;

FIG. 3 is a partial plan view of a replaceable temple, illustrating partial insertion of a male bezel element in an orifice/opening/cavity of the temple, according to an exemplary embodiment of the present invention;

FIG. 4 is a partial perspective view of the outer surface of the replaceable temple shown in FIG. 3;

FIG. 5 is a partial plan view of the replaceable temple shown in FIG. 3, illustrating full insertion of the male bezel element in the orifice/opening/cavity of the temple;

FIG. 6 is a perspective view of a male bezel element, according to an exemplary embodiment of the present invention;

FIG. 7 shows cut away and magnified perspective views of the orifice/opening/cavity of a replaceable temple, illustrating an exemplary raised inner surface into which a mesa portion of a bezel coupled to an eyeglass frame can lock, according to an exemplary embodiment of the present invention (“mesa” in the context of FIG. 7, and in this disclosure in general, refers to rectangular protrusion 712 disposed at the upper surface of the bezel element that has a substantially flat surface; it is this very same protrusion that (i) a user can push down upon, against the force of spring 710, to allow the bezel element to be inserted into the cavity of the replaceable temple, and (ii) locks the mesa into the replaceable temple when the bezel element is fully inserted);

FIGS. 8A-8C are various views of an eyeglass frame, namely a top view illustrating two fully clasped replaceable temples, a side view illustrating the left temple, and a forward view of the front portion of the frame, according to an exemplary embodiment of the present invention;

FIG. 9A is an exploded view of an exemplary eyeglass frame, illustrating the various components of male bezel elements and the manner in which the bezel elements can be inserted into replaceable temples, according to an exemplary embodiment of the present invention;

FIGS. 9B and 9C are exploded side and top perspective views of a replaceable temple shown in FIG. 9A, illustrating its various component parts and the manner in which they can be coupled to one another;

FIGS. 9D through 9G are various partial views of an eyeglass frame, illustrating a replaceable temple, coupled to a hinge, in various flexed states, according to an exemplary embodiment of the present invention;

FIGS. 9H-A to 9H-E are various views of a fully assembled eyeglass frame, according to an exemplary embodiment of the present invention;

FIGS. 10A-10D are side and top views of left and right replaceable temples, according to an exemplary embodiment of the present invention;

FIGS. 11A, 11B, 12A, and 12B are cross-sectional views of the replaceable temple shown in FIG. 10A, taken along the lines 11A-11A, 11B-11B, 12A-12A, and 12B-12B;

FIGS. 13A-13D are side and top views of the rigid portion of left and right bezel elements, according to an exemplary embodiment of the present invention;

FIGS. 14A-14D are side and top views of the non-rigid, or spring portion, of bezel element(s), illustrating the spring portion in various assembly phases, according to an exemplary embodiment of the present invention;

FIGS. 15A-15D are side and top views of assembled, left and right bezel elements including the rigid and non-rigid portions shown in FIGS. 13A to 14D;

FIGS. 16A-16D are side and top views of the assembled, left and right bezel elements shown in FIGS. 15A-15D; and

FIGS. 17A-17E are various cross-sectional views of the assembled bezel element shown in FIG. 16A, taken along the lines 17A-17A, 17B-17B, 17C-17C, 17D-17D, and 17E-17E.

### DETAILED DESCRIPTION OF THE PREFERRED EMBODIMENTS

In exemplary embodiments of the present invention, eyeglass frames with replaceable temples are provided. The frames include a fixed, spring loaded “male” insert attached via a hinge to each side of the frame, and removable “female” temple pieces that have a hollow receptacle for insertion and attachment of the male inserts.

It is noted that a temple piece in an eyeglass frame is a fashion item. People seek interesting and distinctive designs, shapes, colors or prints on their eyeglass temples, and often an eyeglass temple will have various portions in different materials. For example, there may be a rubber material at the end of the temple, to sit on the ear and grip the bones above the ear, followed by a tortoise shell or fluorescent color midsection, and then a metal portion extending from a hinge. Frames nowadays are designed and manufactured by famous designers, and often bear a designer logo. Many variations are possible, all of which illustrate how important temple shape, size, color, material and pattern are to fashion, and a wearer's fashion sense and fashion statement.

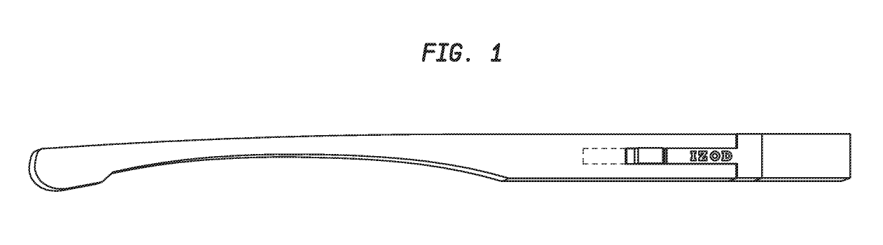

A portion of a novel eyeglass frame using the proposed technology is shown in FIG. 1. The exemplary construction allows for easy replacement of various removable temple pieces, because all that is permanently attached to the frame is the bezel (male) clasp, essentially a stub. A plethora of varied temple pieces may thus be temporarily attached and removed from the bezel clasp, as may be convenient to the wearer. It is noted that the view shown in FIG. 1 is that of the outer side of the frame and temple piece, as would be seen on a wearer's right temple. As shown, a logo can be provided on a narrow portion of the clasp piece that is inserted into a cavity of a removable temple piece.

As can be seen in FIG. 1, the bezel may be provided on the outer side of the temple. This facilitates having a logo or distinctive designer's mark on the bezel, either engraved in, or protruding from the outer surface, as shown. In alternate exemplary embodiments, however, the bezel may be provided on the inner portion of the frame, facing a wearer. In such an alternate embodiment, however, consideration should be given to how far it protrudes towards a wearer's head.

The length of the bezel clasp can be variable. However, if it is made too long, then the tension in the spring may be insufficient and unable to hold the temple piece. On the other hand, if it is too short, then it may be difficult for a user to press down on the “mesa” (described more fully below) so as to release the clasp from the replaceable temple piece and pull out the temple piece. In some embodiments, a useful range can be about 13.9 mm in length, plus or minus about 0.2 mm.

Moreover, whatever the length, the bezel may not protrude farther into the temple piece beyond the point that it narrows, as it may be difficult to provide a cavity in the thin rear portion of the temple piece.

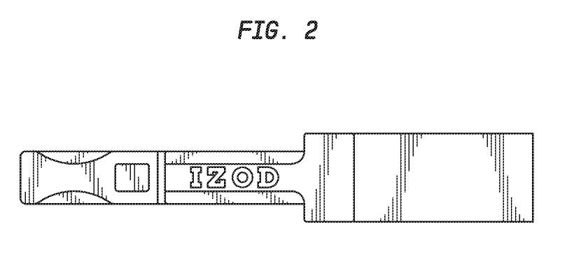

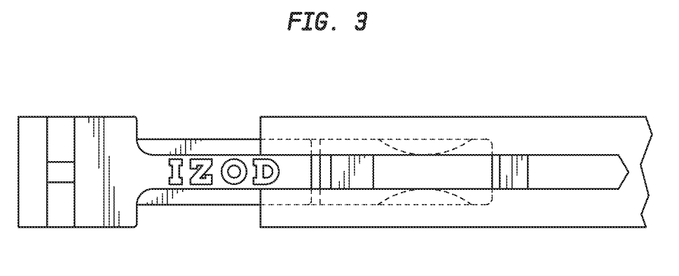

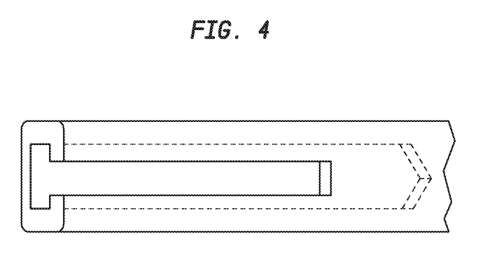

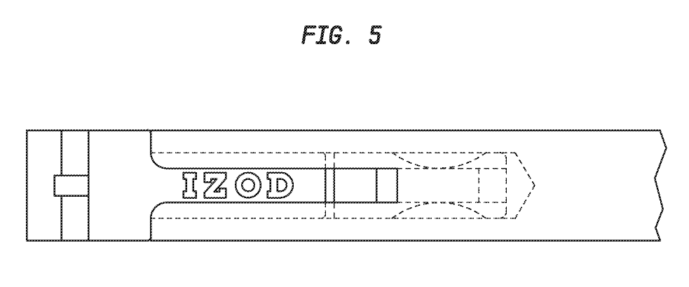

FIG. 2 is a close up view of the bezel clasp shown in FIG. 1. FIG. 3 illustrates how a clasp piece can be inserted into a cavity of a replaceable temple portion, particularly left versions of exemplary clasp and temple pieces. FIG. 4 is a close up view of the temple piece shown in FIG. 3, illustrating its cavity into which the exemplary clasp piece is partially inserted. FIG. 5 is a view of the temple piece shown in FIG. 3, illustrating the clasp piece in a fully inserted position.

Exemplary Clasp/Bezel Piece in Detail

A close up view of an exemplary clasp piece is shown in FIG. 6. The clasp piece can include two portions connected by a hinge. These two main portions can include a thicker front portion 640 that attaches to an eyeglass frame, and a rear portion that includes a thicker portion 620, connected via hinge 630 to front portion 640, and spring 610 and a mesa or locking piece 612 that is insertable into a cavity of a replaceable temple piece. Spring 610 can be connected to thicker portion 620.

According to an exemplary embodiment, it is the spring 610 and mesa 612 that can be inserted into the cavity of a temple piece (see also, for example, FIGS. 1-3 and 5). The front portion 640 on the right side of hinge 630 can be permanently or semi-permanently attached to the eyeglass frame, as described below. Clasp 612 is preferably a mesa, and can be spring loaded by the spring comprising a V-shaped piece of material (e.g., metal) 610, shown in FIG. 6 in its home, or natural, uncompressed, position. As shown, mesa 612 can be provided at the end of spring 610, preferably in the form of a rectangular protrusion. In exemplary embodiments of the present invention, the thicker portions 620 and 640 may be made of metal, such as, for example, a nickel silver alloy, or various other metals and metal alloys, and the spring 610 may be made of a resilient metal, such as, for example, stainless steel. Mesa 612 may be made of either material, but preferably the same material as that of thicker portions 620 and 640, for aesthetic matching. In the exemplary embodiment shown in FIG. 6, no deformation or distortion was seen after a test of 300 times of repeated pressing. The open angle of this exemplary spring 610 is preferably about 10 degrees, with a spring constant of about 0.24 kgf*mm.

In some embodiments, the spring and mesa insert may be made from separate pieces of metal and soldered or attached together. This allows the spring to be made of a metal having high elasticity and durability, and the mesa portion can match the remainder of the hinged parts 620 and 640. It should be appreciated that, when loading the spring into the temple piece, the spring can be compressed from its home or natural angle of about 10 degrees to about 3 degrees. To limit the extent of the deformation, a high quality stainless steel can be used.

Exemplary Temple Piece in Detail

FIG. 7 shows cut away and magnified perspective views of the cavity or opening in a replaceable temple piece according to an exemplary embodiment, illustrating a lowered, or cut away, inner surface 725 into which the bezel's mesa portion 712 can lock. With reference thereto, the bottom drawing shows the spring 710 and mesa 712 fully inserted into the temple piece, and locked into position. The upper (and to the left) drawing shows the spring 710 and mesa 712 prior to such insertion. Additionally, the magnification balloon 701 in FIG. 7 magnifies the temple piece portion of the upper drawing, and shows details of cuts that can be made in the interior of the temple piece to fit the spring 710 and mesa 712, and facilitate the locking in place of the mesa. Thus, 735 illustrates the long longitudinal cut made to accommodate the folded over piece of metal (i.e., spring 710), and 725 indicates the deeper cut made to accommodate and hold the mesa portion. This latter deeper cut 725 begins at 723, as shown. Index number 720 points to the inner (interior) wall of the temple piece's cavity at its initial inner edge, somewhat frontward (i.e., towards the frame) of the area of the deeper cut at 725. Index number 715 illustrates the direction along which the clasp portion can be inserted into the temple piece, i.e., into the cavity of the temple piece, according to exemplary embodiments of the present invention.

In operation, as shown in FIG. 7, the clasp (male) piece, which can be attached to the front of the frame where the lenses are provided, can be inserted into the cavity of the removable temple (female) piece. To achieve this, a user can compress the spring 710 by pressing onto mesa 712. Once inserted, the spring of the clasp then pushes the rectangular protrusion or bezel against the interior wall of the cavity within the temple piece such that the clasp seeks to be flush against it, initially at 720. As the user continues to push the clasp piece inside the cavity, once the mesa reaches the deeper cut at 725, beginning at 723, the mesa of the clasp piece can, by action of the spring, be pushed outward into the additional deeper cavity 725, thus locking it into place. The mesa 712 can prevent the clasp portion from being extracted from the deeper cavity 725 without the user again pushing on the mesa to allow its top surface to once again clear the beginning 723 of the deeper cut 725, and thereby being capable of extraction.

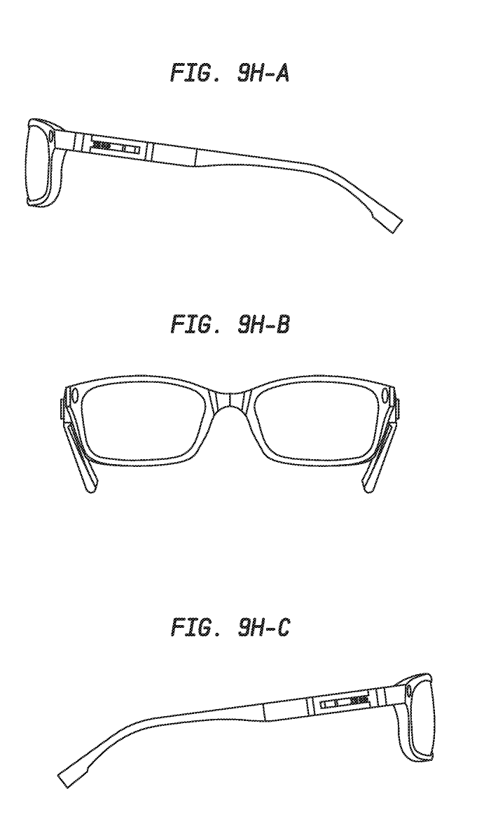

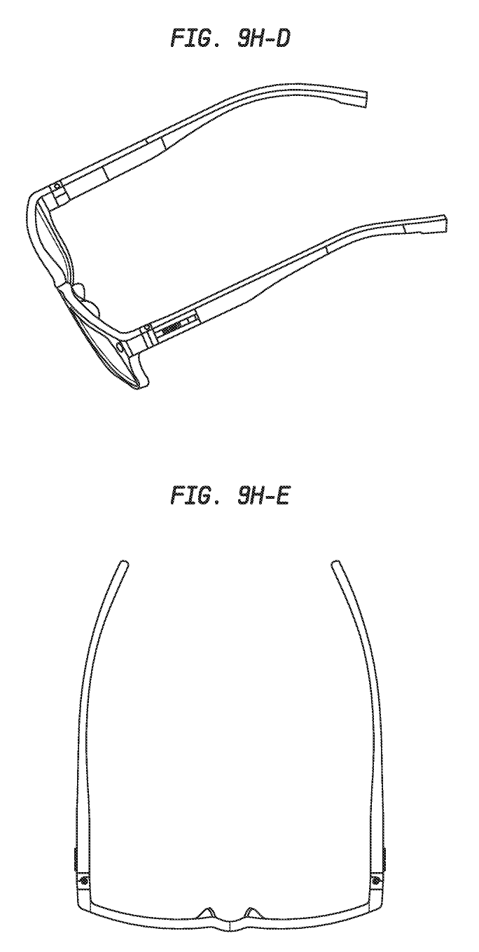

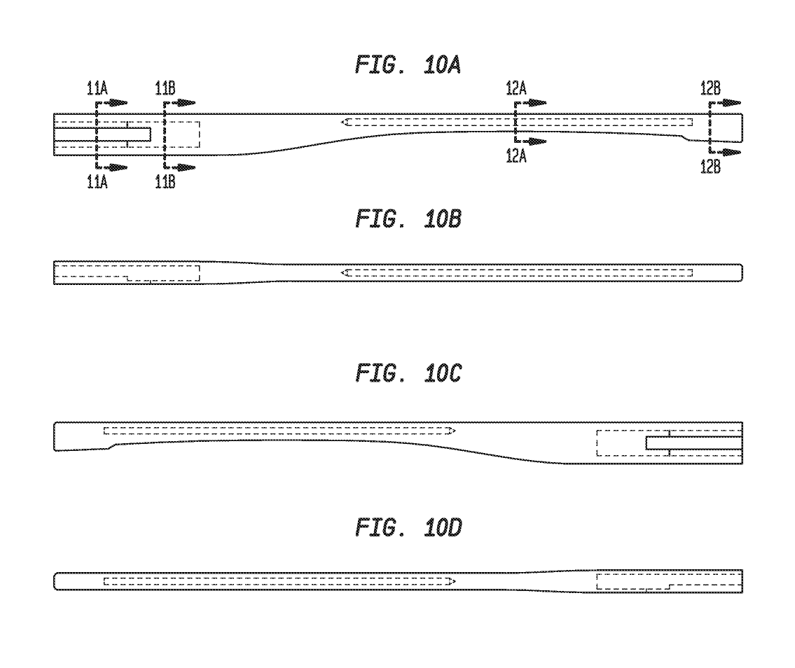

In an exemplary embodiment of the present invention as shown in FIGS. 10A-10D, for a temple piece having a width of about 4.5 millimeters, for example, the additional cut to hold the bezel protrusion locked into place can be about 0.5 mm, with a tolerance of about +0.1 mm and −0 mm. This can be seen, for example, by comparing the cross sections taken at 11A-11A and 11B-11B in FIG. 10A. These respective cross-sections are shown in FIGS. 11A and 11B. With reference thereto, the width of the cavity at 11A-11A can be about 2.1 mm, but the cavity depth at 11B-11B can be about 2.6 mm. Thus, at the position of cross-section 11B-11B, along the temple piece, which is further rearward, or towards the ear piece, there can be about a 0.5 mm step of a greater or deeper cut away in the interior wall of the temple piece, and this step can be used as the “hook” 723 and the additional deeper cut away area 725 that holds the mesa 712 in place, as shown in FIG. 7, and as described above.

As noted, exemplary constructions of the present invention are embodied in prototype clasp and temple pieces shown in FIGS. 7 to 9H-E, designed, for example, to accommodate a designer logo of a recognizable size on a portion of a clasp piece disposed rearward of the hinge. In these particular embodiments, the logo is “IZOD.”

As noted above, to remove a temple piece, a user can push on the mesa (e.g., rectangular protrusion), thereby releasing the snap fit, and allowing the temple piece to be removed, and another removable temple piece to be attached.

Preferably, the temple portion is made of a material hard enough to hold the precise cuts to facilitate the bezel clasping, but flexible enough to bend so as to accommodate the wearer's head. For example, the temple piece may be injection molded out of TR-90 or polycarbonate (“PC”). In some embodiments, where it is desired to insert a core wire into the rear portion of the temple piece for strength and bendability, TR-90 may be preferable. For example, PC may be too stiff to insert a tip core wire. Thus, to allow the temple tip to bend, as shown in FIGS. 10A-10D, for example, TR-90 can be selected for the exemplary temple pieces.

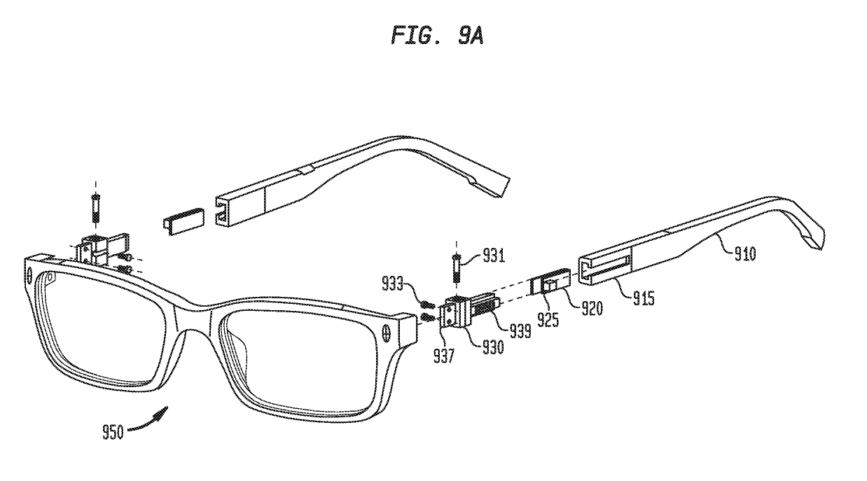

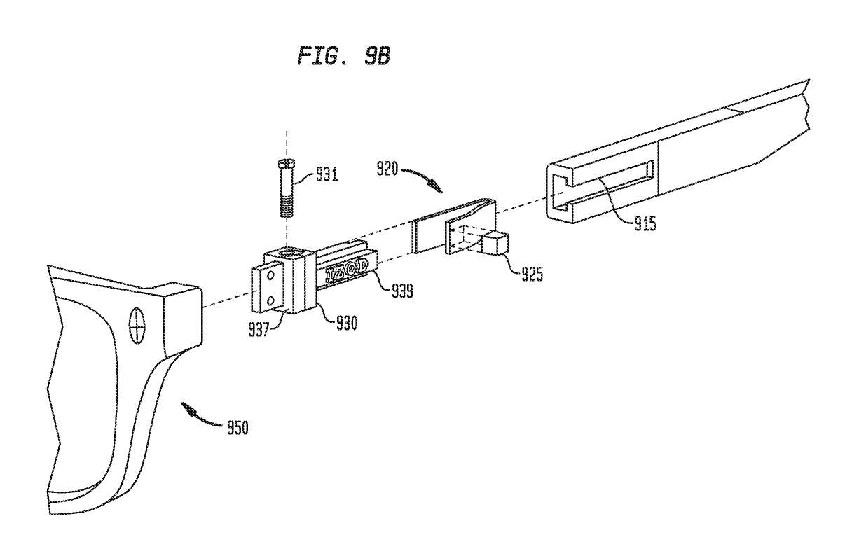

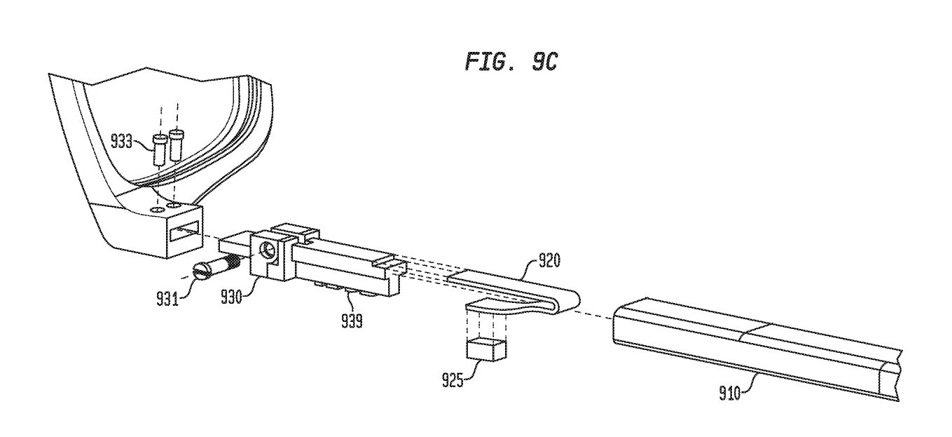

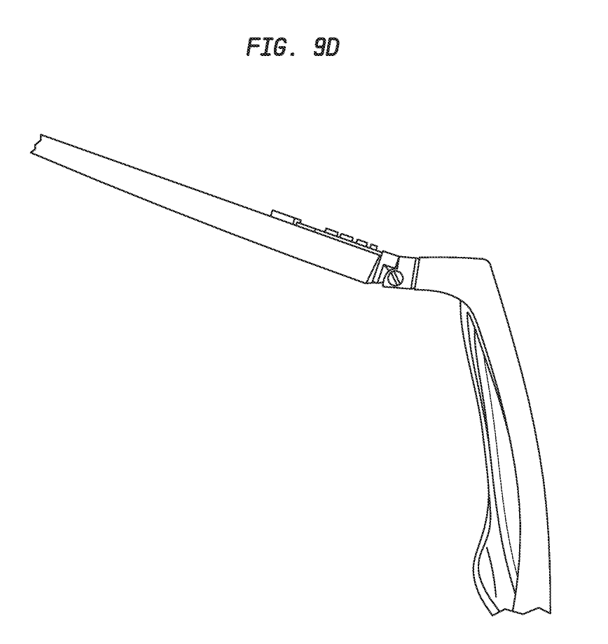

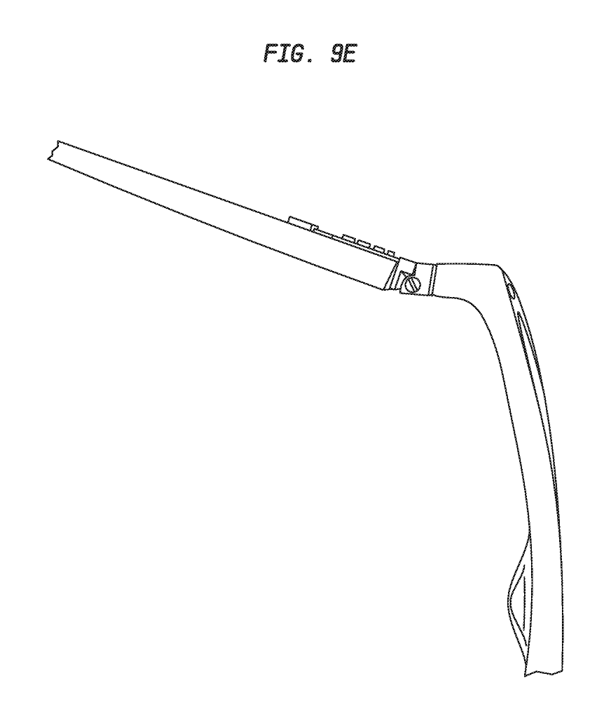

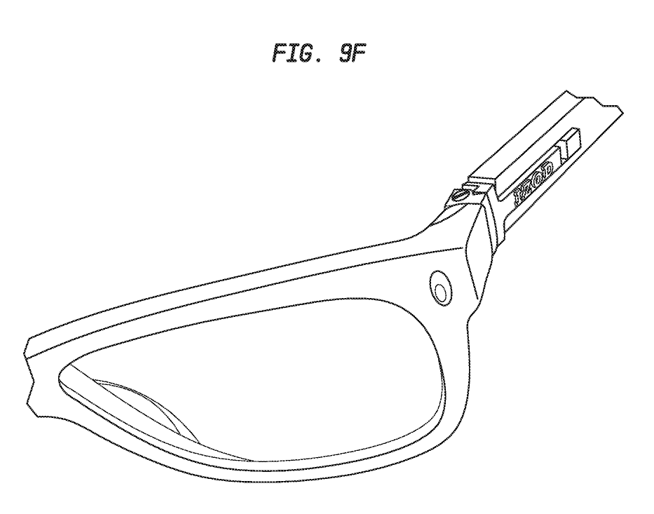

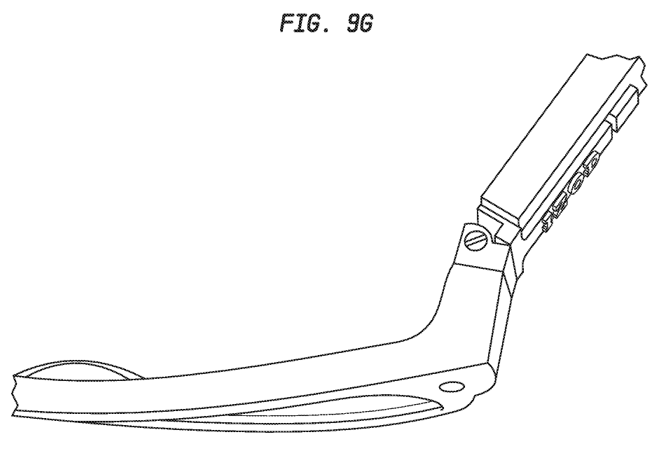

To connect the temple piece to the frame piece, the clasp can be inserted into a cavity in the front portion of the removable temple. See, for example, FIGS. 7 and 9A-9C.

In some embodiments, the tolerances between the (e.g., metal) clasp insert and the hole in the (e.g., plastic) temple piece can be about +/−0.15 mm. Depending on repeated use, the edges of the cavity in the temple piece may wear out over time, but when that happens, it is a simple matter to obtain a new set of temple pieces. The clasp insert, being metallic, for example, is not expected to wear down due to attachment and detachment from the temple pieces.

Exemplary Eyeglass Frames

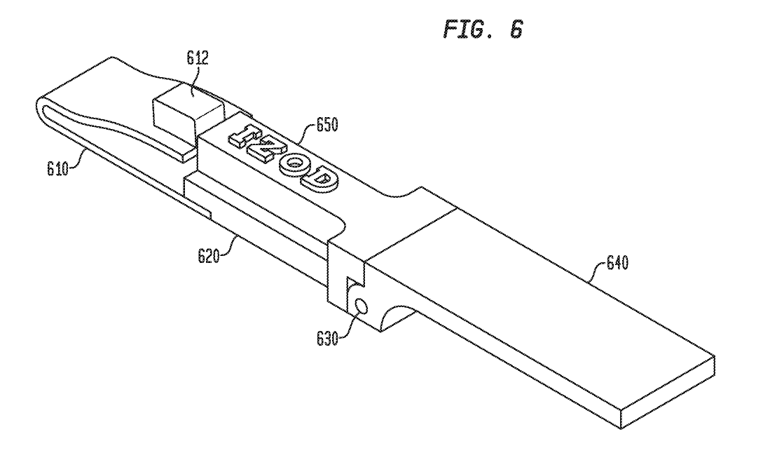

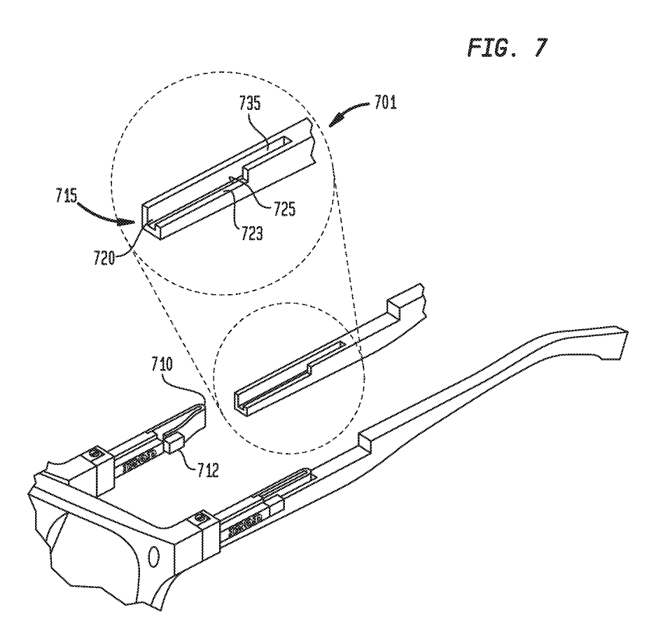

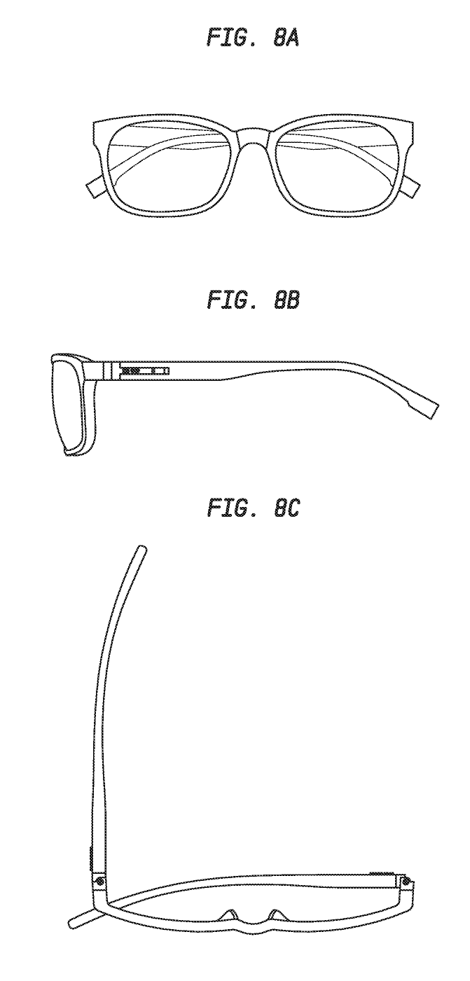

FIGS. 8A-8C are various views of an eyeglass frame according to an exemplary embodiment of the present invention, namely a forward view of the front portion of the frame, a side view of the left temple, and a top view showing two fully clasped replaceable temples. It is noted that any and all dimensions provided in this disclosure are for illustrative purposes only, and are not in any way limiting.

FIG. 9A is an exploded view of an exemplary eyeglass frame, illustrating the various components of male bezel elements and the manner in which the bezel elements can be inserted into replaceable temples.

FIGS. 9B and 9C are exploded side and top perspective views of a replaceable temple shown in FIG. 9A, illustrating its various component parts and the manner in which they can be coupled to one another. With reference thereto, there is shown in each of FIGS. 9B and 9C, in various levels of magnification, temple piece 910, with cavity 915. The clasp piece is shown in an exploded view. The components of the clasp piece can include spring 920, mesa 925, and two preferably metallic portions connected by hinge 930, using hinge screw 931. The two metallic portions can include (i) a protrusion 937 for insertion into frame 950 via screws 933 (not shown in FIG. 9B, but shown in both FIGS. 9A and 9C), and logo bearing portion 939. FIG. 9B illustrates how mesa 925 can initially be separate from, but attachable to, spring 920. It further shows how spring 920 can initially be separate from, but attachable to the logo bearing portion 939. FIG. 9C is a view of the same components shown in FIGS. 9A and 9B, but from a top view.

Exemplary Frames with Spring Hinge

FIGS. 9D through 9G are various partial views of an exemplary eyeglass frame, illustrating a replaceable temple, coupled to a hinge, in various flexed states. The front portion of the frame (which holds the lenses) can be composed of plastic, and the replaceable temple piece can be composed of TR-90. The insert into the replaceable temple can include a designer logo on the outer surface (see also, e.g., index number 939 of FIG. 9B). As may further be seen, and also precisely as described above, the insert to the replaceable temple can be connected to the front portion of the frame via a hinge.

As can be seen in FIGS. 9D-9G, the hinge can allow the temple piece to be expanded such that the angle between the frame and the temple piece is greater than 90 degrees. This is by virtue of the spring hinge used in these exemplary embodiments. A spring hinge (or “flex hinge”) is the second most common type of hinge used in eyeglasses (the other type is the “standard hinge”). Spring hinges are equipped with a small integral spring that affords the arms or temples a greater range of movement and does not limit them to the traditional, 90 degree angle from the frame. These hinges provide greater comfort for the wearer and are more able to withstand everyday use. Most spring hinges are constructed with three barrels.

Spring hinges require fewer adjustments. While it is still recommended to consult one's optician if these frames are falling off of one's face, the likelihood of this happening right out of the package is low. Unlike standard hinge frames, spring hinge frames also have “give and take” to them. This gives the customer a comforting “squeeze” (or, as they say, “glasses hug”) that lets the wearer know their glasses are always there. Moreover, spring hinges are better for physical activity. Due to their snug fit, spring hinge frames are more likely to stay on while running or jogging, for example, which makes them a good choice for people with an active lifestyle or for children's glasses.

Thus, unlike standard hinged eyeglass frames, which have a maximum opening of 90 degrees, in exemplary embodiments of the present invention, the eyeglass frames may be provided with spring hinges. The maximum opening angle of the spring hinge depends on the type and size of the spring mechanism used within it. Since, in the exemplary interchangeable (replaceable) temple eyeglass frames shown in FIGS. 9D through 9G, the hinge spring is integrated into the logo design for a clean look, the spring can be somewhat smaller than would otherwise be possible. This may not allow for the same degree of opening as, say common spring hinged sunglasses, for example.

FIGS. 9D and 9E show the exemplary frame, where the angle between the temple and the frame is approximately 120 degrees. FIG. 9F shows clearly the designer logo on the temple insert, and the spatial relation between the frame and the temple when the hinge is opened outwardly. Finally, FIG. 9G is a close up top view of the opened hinge, which is here opened even more than in the previous figures. As can be seen in FIG. 9G, due to the integral spring, the arm can be moved outward and the components of the hinge separate slightly relative to a standard hinge.

FIGS. 9H-A to 9H-E are various views of a fully assembled, exemplary eyeglass frame.

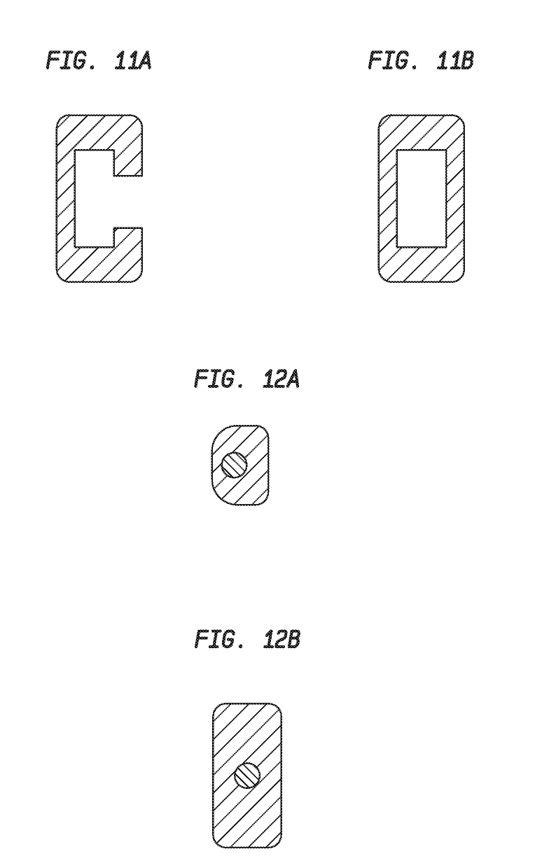

FIGS. 10A-10D are side and top views of a left temple piece and a right temple piece, according to an exemplary embodiment of the present invention. More particularly, FIGS. 10A and 10B are side and top views of an exemplary right side temple piece, and FIGS. 10C and 10D are analogous drawings of an exemplary left side temple piece. FIG. 10A further indicates various lines for which cross-sections are provided, namely lines 11A-11A, 11B-11B, 12A-12A, 12B-12B, and those cross sectional areas are provided, respectively, in FIGS. 11A to 12B.

The design considerations which were used for this exemplary embodiment, and which thus factored into its ultimate dimensions, are merely illustrative and non-limiting, but useful to understand. They include the following:

1. The (IZOD) logo size on the rear portion of the metal hinge should be large enough so that one can see the letters at a reasonable distance from the wearer. In some embodiments, it is aesthetically desirable to have the height of the portion of the hinge on which the designer logo is provided to have the same or similar vertical dimension as the mesa, as shown, for example, in FIG. 2. Thus, the logo piece can be centered vertically on the overall rear portion of the hinge, which preferably has the same or similar vertical dimension as the height of the spring. Given these concerns, a value of about 2.5 mm can be chosen for the vertical dimension of the clasp insert. The size of the open hole of the temple can also be about 2.5 mm.

2. To ensure both sufficient strength of the temple, and the ability of the metal spring to hold the temple securely, the temple height can be set to be about 8 mm. In particular, because of the cavity in the temple piece that receives the metal insert and clasp, there are some areas where the injected temple may be rather thin, as shown in FIG. 7, for example. If these parts are too thin, then the injected temple sleeve may be weak, and may easily have quality issues. By making the temple height about 8 mm, for example, there can be sufficient thickness even in these thinnest portions of the cavity to be robust. Moreover, this height can allow sufficient room to enable the hook design inside the cavity (e.g., protrusion 725 in FIG. 7) to secure the metal spring.

3. Temple length can be determined by the front portion size. For cosmetic/aesthetic reasons, various exemplary embodiments shown in FIGS. 10A to 17E can be set at about 137.5 mm before the hinge screw, for an overall temple length of about 140 mm. Such an exemplary temple piece can also be made at an overall length of about 145 mm. The front portion size can be determined by the frame's ‘A’ measurement. Thus, if one or more of the exemplary frames shown in FIGS. 10A to 17E has a larger ‘A’ measurement, it may be more suitable for “larger” users. The temple length should also be long, or it may not be comfortable to wear. By the same reasoning, if a given frame has a narrower ‘A’ measurement, the frame may be more suitable for “smaller” users with narrower heads, such as children. In this scenario, the temple length should be shorter, or it may look strange and also be uncomfortable.

It is to be appreciated that the constructions shown in FIGS. 10A to 17E are only exemplary, and that, by appropriate scaling, various alternate exemplary embodiments of the present invention may be made and implemented in a large variety of various sizes.

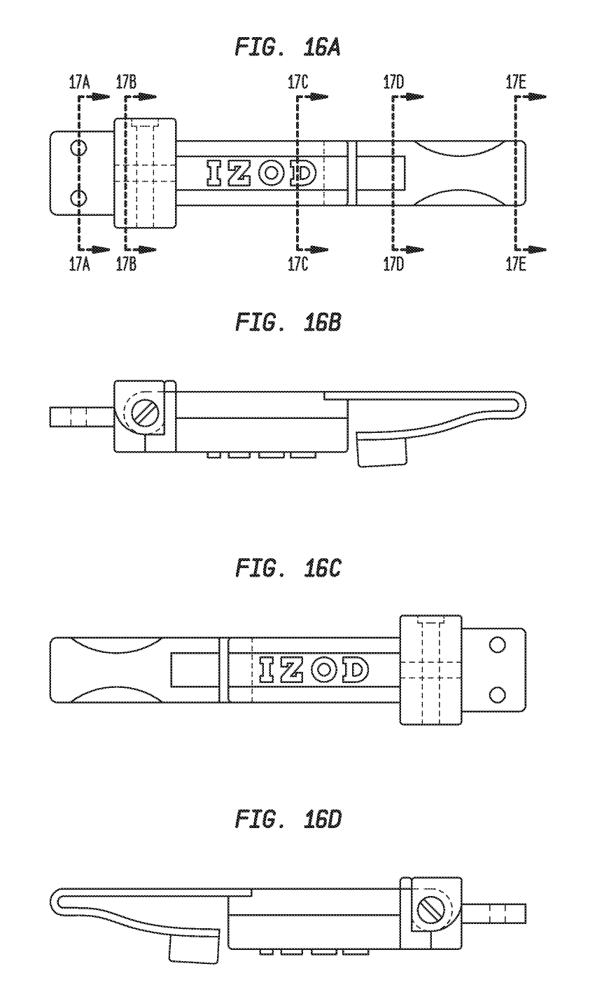

4. The spring length can be chosen to suit most users, on average. The countervailing factors in choosing spring length are: (i) not to require users to exert too much effort to press the bezel, but at the same time (ii) be strong enough to hold the temple in place. The spring length can be chosen, for example, to be about 13.87 mm, after being folded over (see, e.g., FIG. 16A).

Detailed Views of Exemplary Bezel Pieces

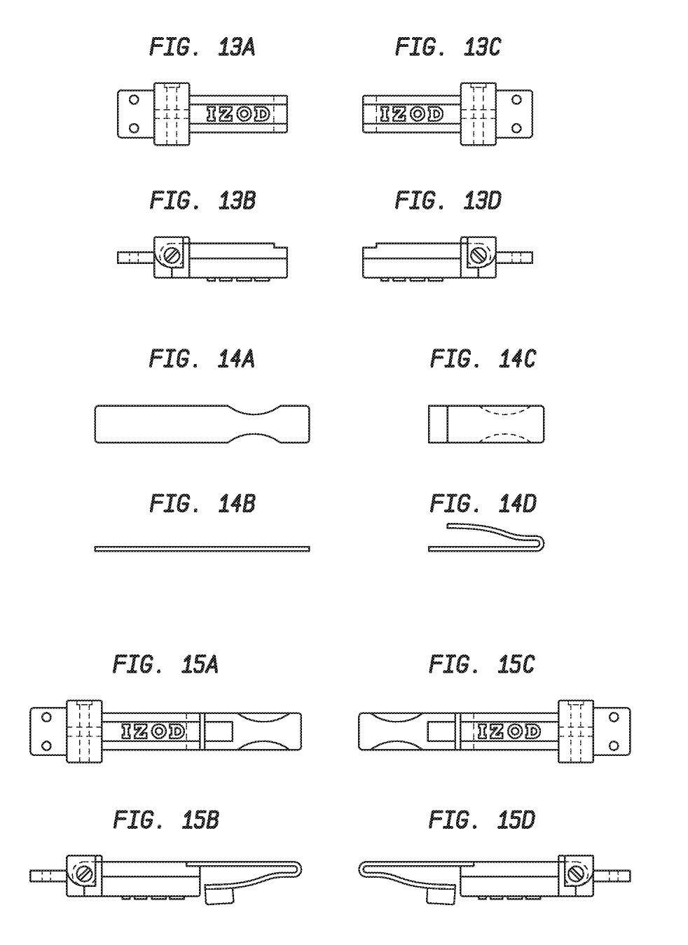

FIGS. 13A-13D are side and top views of the rigid portion (i.e., not the spring) of left and right bezels according to an exemplary embodiment of the present invention. FIGS. 14A-14D illustrate various steps in assembling the non-rigid, or spring portion, of bezel(s) in side and top views according to an exemplary embodiment of the present invention. With reference thereto, as shown in FIG. 14B, a flat piece of resilient metal, such as for example, stainless steel, can be provided with elliptical cut outs on one side. The purpose of these cut outs is to decrease the weight of the upper bent over portion of the spring, so as to give it greater flexibility. The mesa protrusion that is soldered on the mechanism does not have these cuts and it thus has more weight relative to the upper bent over portion of the spring. The inventors found that flexibility was less for springs without the elliptical cuts, and thus they are a preferred exemplary embodiment. However, in other embodiments, a spring can be made without them.

As shown in FIGS. 14C and 14D, the piece of metal can be folded over, with the portion having the cut outs on top, to make a spring. The fold over creates a pinched portion 1310 (seen at the left end of FIG. 14D) of the metal in a fixed “hairpin” shape, at a fixed distance between the upper and lower layers of the spring. The remainder of the piece can move between, for example, an angle of 10 degrees to a much smaller angle, depending upon the force applied by a user.

FIGS. 15A-15D are side and top views of both left and right bezels, illustrating the connection of the portions shown in FIGS. 13A to 14D to arrive at the fully assembled clasp pieces. The mesa protrusion can be soldered onto each bezel to achieve the locking functionality, as described above.

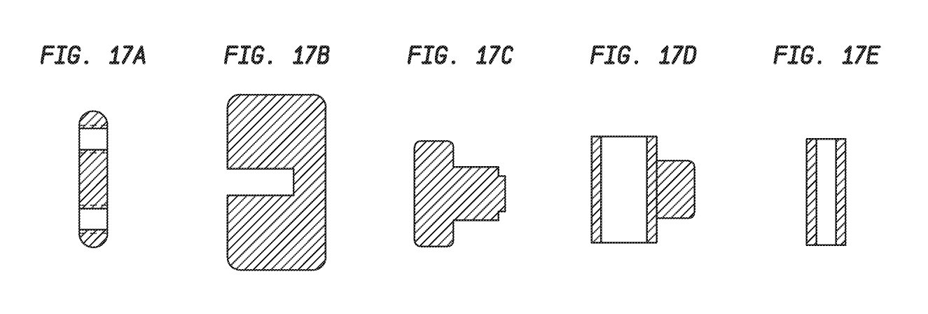

FIGS. 16A and 16B are side and top views of the fully assembled left and right bezels shown in FIG. 15A-15D. Similar to FIGS. 10A-10D, FIG. 16A indicates positions along the length of the clasp where cross sections are taken, as shown in FIGS. 17A-17E. In particular, FIGS. 17A-17E illustrate the five cross-sectional views taken along the cross sections 17A-17A, 17B-17B, 17C-17C, 17D-17D, and 17E-17E shown in FIG. 16A.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. The above-presented description and figures are intended by way of example only and are not intended to limit the present invention in any way.

It is also to be understood that the following claims are intended to cover the generic and specific features of the inventive embodiments herein described, and all statements of the scope of the invention that, as a matter of language, might be said to fall therebetween.

What is claimed:

1. An eyeglass frame, comprising:
a front portion including openings for lenses;
two side portions, each side portion comprising a front piece and a rear piece connected by a hinge, the front piece attached to one side of the front portion, and the rear piece including a tensioning device and a locking portion; and
two temple portions, each temple portion comprising a cavity arranged to accept a rear piece of said side portion,
wherein a temple portion can be releasably attached to said rear piece by inserting said rear piece in said cavity, and allowing the tensioning device to lock the locking portion in place.

2. The eyeglass frame of claim 1, wherein said front portion is provided with one of prescription or non-prescription lenses.

3. The eyeglass frame of claim 1, wherein said rear piece of at least one of said side portions is provided with a logo.

4. The eyeglass frame of claim 3, wherein at least one of:
the logo is large enough to be read from a reasonable distance away from a wearer of the eyeglass frame, and
the logo is made of raised letters or symbols relative to a surface of the rear piece.

5. The eyeglass frame of claim 1, wherein each side portion is made of metal.

6. The eyeglass frame of claim 1, wherein the rear piece of the side portion comprises a solid portion, the tensioning device being attached to the rear of the solid portion.

7. The eyeglass frame of claim 6, wherein the locking portion is one of integrated with or attached to the tensioning device.

8. The eyeglass frame of claim 1, wherein at least a portion of the rear piece of the side portion is made of at least one of: stainless steel, monel, a metal, or a metal alloy.

9. The eyeglass frame of claim 6, wherein the solid portion of the side portion is made of at least one of: stainless steel, monel, a metal, or a metal alloy, and wherein the tensioning device is made of a resilient metal.

10. The eyeglass frame of claim 9, wherein said resilient metal is one of stainless steel, monel, a metal, or a metal alloy.

11. The eyeglass frame of claim 1, wherein the temple portions are made by injection molding a plastic.

12. The eyeglass frame of claim 11, wherein the temple portions are made by injection molding TR-90.

13. The eyeglass frame of claim 1, wherein to attach the side portion to the temple portion, the rear piece of the side portion is fully inserted into the cavity of the temple piece.

14. The eyeglass frame of claim 8, wherein the locking device is also made of at least one of: stainless steel, monel, a metal, or a metal alloy.

15. The eyeglass frame of claim 1, wherein the cavity has varying depth along a longitudinal dimension of the temple portion, with the greatest depth at a position where the locking device fits into place.

16. The eyeglass frame of claim 1, wherein the hinge is either a standard hinge or a spring hinge.

17. The eyeglass frame of claim 16, wherein the hinge is a spring hinge, and wherein the spring mechanism is integrated into a logo design provided on the rear piece of each side portion.
